(19) United States
(12) Patent Application Publication
(10) Pub. No.: US 2004/0139002 A1
(43) Pub. Date: Jul. 15, 2004

(54) Micropayment system

(76) Inventors: Horst Henn, Boeblingen (DE); Thomas Schaeck, Achern (DE); Martin Smolny, Boeblingen (DE)

Correspondence Address: Marilyn Smith Dawkins, International Business Machines, Intellectual Property Law, 11400 Burnet Road, Austin, TX, 78758, US

(21) Appl. No.: 10/476,946

(22) PCT Filed: May 14, 2002
(86) PCT No.: PCT/EP02/05283

(30) Foreign Application Priority Data
May 31, 2001 (EP) 01113257.8

(51) Int. Cl. G06F 17/60

(52) U.S. Cl. 705/39

(57) ABSTRACT

A network-based method for performing cashless payments between a customer and a vendor providing services in the network is provided, whereby an amount from a customer's account at a trusted third party is debited by the vendor for each access of the customer to the vendor's services provided on the network. The method comprises the step of assigning a limited maximum amount to the customer's account and allowing the vendor to debit the customer's account at the trusted third party for each access to the vendor's network service until the limited maximum amount is reached by performing a single authorization step for the assigned limited maximum amount before the first access to the vendor's network services.

### FIELD OF THE INVENTION

The present invention relates to a commercial network transaction method and system. More particularly, the invention relates to such a method and system for performing cashless payments between a customer and a vendor providing services in said network.

### BACKGROUND OF THE INVENTION

Commercial Internet payment systems are now being developed. Just as cash and credit exist in conventional business transactions, both exist in the digital world as well. Digital cash is the digital equivalent of a cashier's check issued and signed by a bank or other institution with its name, unique identification and amount of money represented. Users or customers can buy these notes or coins from a bank and then redeem them later for real cash, typically as a deposit to a bank account.

Several examples of Internet payment systems already exist. Many of these systems are account-based; that is, both the customer and the merchant or vendor have accounts with the system. Thus, there is no provision for anonymity. Privacy is an important issue which is only partially addressed in some systems. Security is critical to all Internet payment systems and the encryption techniques adopted vary widely.

Typically, inexpensive items such as newspaper or candy bars are paid for in cash, since the costs of other payment systems, such as checks or credit cards, are too high for such small transactions. Electronic commerce, however, is expected to lead to a dramatic growth in even smaller transactions, in some cases, transactions for less than a penny, such as purchases of individual news stories.

Most of the conventional electronic payment systems are inadequate for handling “micropayments” because of either computational or communications burdens. Therefore, a number of electronic micropayment systems have been developed. While these systems do not provide all of the features of conventional electronic payment schemes, they are more efficient and provide adequate features for the small sums involved in micropayments.

Systems such as Digicash and NetCash allow the customer to deposit cash into a bank then use that cash to purchase items off the internet. Digicash customers receive an encoded 64 bit number for each cent they convert to ecash, which is then transferred to the user's hard drive. The customer can then transfer the cash to vendors on the internet (as long as the vendor accepts this form of payment). The vendor then returns the cash to the bank in exchange for real money.

As already mentioned before, many information vendors on the internet are accessed by consumers only once or twice for only small amounts of particular information at a time. To operate competitively, the information vendor must charge the consumer only a few cents for each access.

There are essentially two approaches to the pay-per-access problem: token-based and account-based. Protocols are built up around methods based on each of these approaches; a protocol, as used here, is a specific implementation of a method of charging for a consumer's access to a vendor's information or services.

In general, token-based methods have a consumer purchase electronic tokens from a bank. To access a vendor's information, the consumer will pay the vendor using the tokens. The vendor can then go to the bank and deposit the tokens or redeem them for money. An account-based method works like a charge-card method of paying for merchandise. A consumer authorizes a bank to transfer funds from the consumer's account to a vendor's account in exchange for receiving information from the vendor. The fund transfer is performed by the bank.

U.S. Pat. No. 5,930,777 discloses a method for charging a consumer for access, over a network, to a vendor's information; in particular, a method for this pay-per-access over the Internet. The method uses a third-party, called a banker, to mint tokens identified with particular information a consumer might want to purchase. The tokens are immediately available to the consumer because of the consumer's having already established an account with the banker, and purchased what are called credit units, which can have a value of only a fraction of a cent, allowing vendors to charge very little for access to their information. A token is pre-authorization for a consumer to pay for access for a particular page of information. When a consumer makes a purchase, i.e. chooses to access a Web page for which a vendor makes a charge, the transaction is routed through the banker, which charges in credit units (those already on account), and credits the vendor account. The vendor later redeems for payment whatever credit units have been credited to the vendor's banker account, not necessarily only those credit units resulting from transactions with a particular consumer.

In U.S. Pat. No. 5,999,919, there is disclosed a “hybrid” scheme which combines the advantages of both “on-line” and “off-line” electronic payment schemes. It allows for control of overspending at a cost of only a modest increase in communication compared to the off-line schemes. The protocol is based on probabilistic polling. During each transaction, with some small probability, the vendor forwards information about this transaction to the bank. This enables the bank to maintain an accurate approximation of a customer's spending. The frequency of polling messages is related to the monetary value of transactions and the amount of overspending the bank is willing to risk. For transactions of high monetary value, the cost of polling approaches that of the on-line schemes, but for micropayments, the cost of polling is a small increase over the traffic incurred by the off-line schemes.

Finally, U.S. Pat. No. 5,692,132 discloses a commercial transaction system, wherein a system user uses a personal computer to interact with merchant computers over the Internet to conduct cashless transactions. Each system user computer processes data including a balance stored in the computer's memory and updates the stored data at the end of the transaction. The system is specially designed for purchases of items or transactions of relatively small monetary value. In this manner, the amount of the transaction is deducted from the balance on the computer. In accordance with the invention, when the existing balance associated with the computer does not cover the price of the transaction, the system provides a reload feature which gives the user an option to increase the balance of the computer. Such a feature allows the purchase to be made without inconveniencing the user to increase the balance by other means. Each time the balance is increased by a reload, the users issuer bank bills the user for the reload amount.

However, today's micropayment systems have the big disadvantage that they usually require authorization for each single payment, like, e.g., Qpass or IBM Micro Payments). This means that, even for smallest amounts, each transaction has to be authorized by a confirmation click or even by providing a user ID and a password or a PIN. Authorizing every click that would debit the customer's account is restricting the reading flow or work flow. For providers or vendors that are offering memberships with flat rates that are paid, e.g., monthly, there are further problems. Many users are not willing to pay such monthly fees and they are often not willing to be a member of many different poviders as well.

### SUMMARY OF THE INVENTION

It is therefore an object of the present invention to provide a network-based method and system for performing cashless payments between a customer and a vendor providing services in said network that overcomes the above mentioned disadvantages.

It is a further object of the invention to provide such a method and system that is useful in performing micropayments.

These and other objects and advantages are achieved by the method disclosed in claim 1 and the system disclosed in claim 22.

Advantageous embodiments of the invention are disclosed in the dependent claims.

### BRIEF DESCRIPTION OF THE DRAWINGS

The invention will in the following be described in more detail in conjunction with the drawings, in which

FIG. 1 is a scheme showing pay-per-access according to the state of the art;

FIGS. 2A and 2B depict a scheme showing pay-per-access according to the invention;

FIG. 3 is an example of the method according to one embodiment of the invention;

FIGS. 4A to 4D show an example of a screenshot for the procedure according to the invention, including an optional billing monitor according to one embodiment of the invention; and

FIG. 5 depicts a sample scenario for using the invention in conjunction with WebServices.

### DETAILED DESCRIPTION OF THE PREFERRED EMBODIMENT

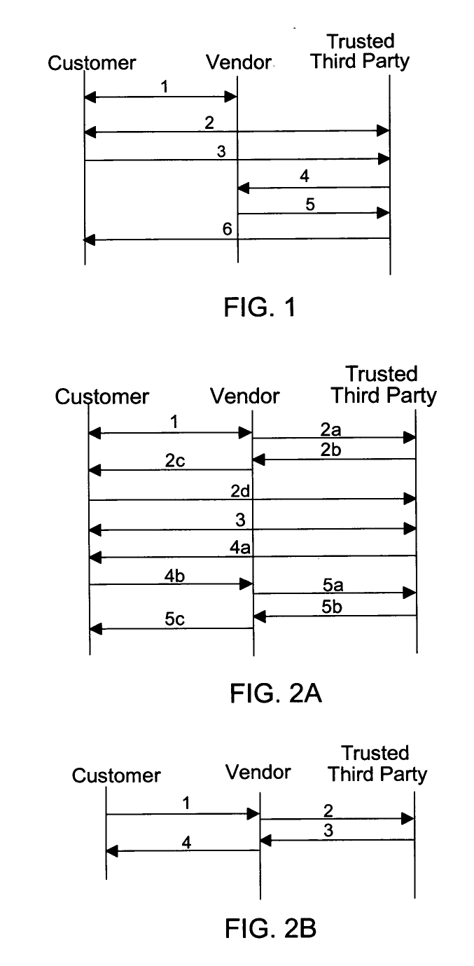

FIG. 1 is a scheme showing pay-per-access according to the state of the art.

A person (hereinafter called “customer”) browses the service or goods overview of a provider or merchant (hereinafter called “vendor”) (1). After the customer has located a service or good, the provider redirects the user to a trusted third party, e.g., a company like FirstGate. The customer must then authorize himself to the trusted third party (2). In step (3), the customer must now confirm the original request. Subsequently, the trusted third party requests the service or good from the vendor ((4) and (5)) and returns it to the customer (6). Each new request for a service or good entails the whole process of authorization, confirmation, etc. The trusted third party accumulates debits and credits for both the customer and the vendor and charges them, e.g., once a month.

FIG. 2A schematically shows the authorization cycle according to the invention. The authorization cycle described here is a general mechanism suitable for mobile phones, personal digital assistants (PDAs), etc. It will be described in more detail in the following with the example of browsing, using HTML. However, it is to be mentioned that the invention is not limited to this example.

A customer or a software, e.g., an agent program that automatically requests news using user-defined criteria, requests, etc., requests services or goods from a service provider or vendor (1). The vendor is connected with a trusted third party, e.g., a third party billing system, a bank, a specialized company (collection agency) or a subsidiary of a software company and a bank, and requests said billing system for billing the customer's activity (2a). The first time this request is sent to the third party, it is rejected due to a missing authorization (2b). The vendor therefore returns a respective request for authorization to the customer (2c). This request is implemented on a device dependent manner. If the customer is a person using a web browser, the browser is automatically redirected to the third party billing system (2d). The customer and the third party system now communicate through a billing authorization protocol that is described in the following. This protocol is specific to each device type.

First the customer identifies himself to the third party system. Using a web browser, this protocol would send a user ID and a password whereas, using a mobile phone, a unique ID could be sent. In case of a PDA, e.g., a signature calculated by a security smart card could be sent. Non-interactive software (an automatic agent software or system requesting computing services) would be able to authenticate itself by a user ID and password or a private key authenticated message. Many other authentication mechanisms are possible, like biometric authentication methods, e.g., a retina scan of the customer's eye.

The third party system presents an input facility for registering a billing limit per provider. Optional instructions like a time limit and service type restrictions can be set there, too. This input facility and its method of transmission is specific to each device type as well. In case of using a web browser, the third party system would present a web page with input fields. Mobile phones may present this facility by WAP pages, a method similar to web pages. Non-interactive software is sending a defined message to the third party system without an input facility. The third party system stores the limits and restrictions for further use.

After the above described billing authorization protocol, the third party system redirects the customer to the originally requested service or good. A web browser, e.g., would receive a redirect information from the third party system (4a). The same would happen in case of mobile phones or PDAs. Non-interactive software would skip step (4a). All devices previously mentioned would repeat the former request (4b)—interactive devices because of the redirect request in (4a), non-interactive software automatically.

Now the vendor requests the billing of the service by the third party system (5a). This time the vendor is authorized, the automated billing is executed and the acknowledgement is passed to the vendor (5b). Subsequently, the customer gets the result (5c). In case of a requested service this would be the result of a calculation, a news article or anything similar. If the request was used to retrieve goods, the result could be a confirmation of the successful billing, if the goods are downloadable software, the download could start.

Once this authorization cycle has been gone through by the customer before the first access to the vendor's network services, a standard processing takes place each time the customer accesses the vendor's services again. This standard processing is shown in FIG. 2B. First, the customer requests a service from the vendor (1). The vendor tries to debit the user's account at the third party billing system (2). This time, since the authorization cycle has been performed previously, the third party system accepts the billing and returns a message (3), indicating a successful billing. The vendor now fulfils the customer's request by delivering the requested services (4).

As already mentioned before, this standard processing is repeated. Every time the customer requests a service and therefore the vendor tries to debit the customer's account, the customer's chosen vendor specific limit is checked by the third party system. If a request is refused by the billing system because of an exceeded account or time limit or a customer chosen service type restriction, the authorization cycle is restarted.

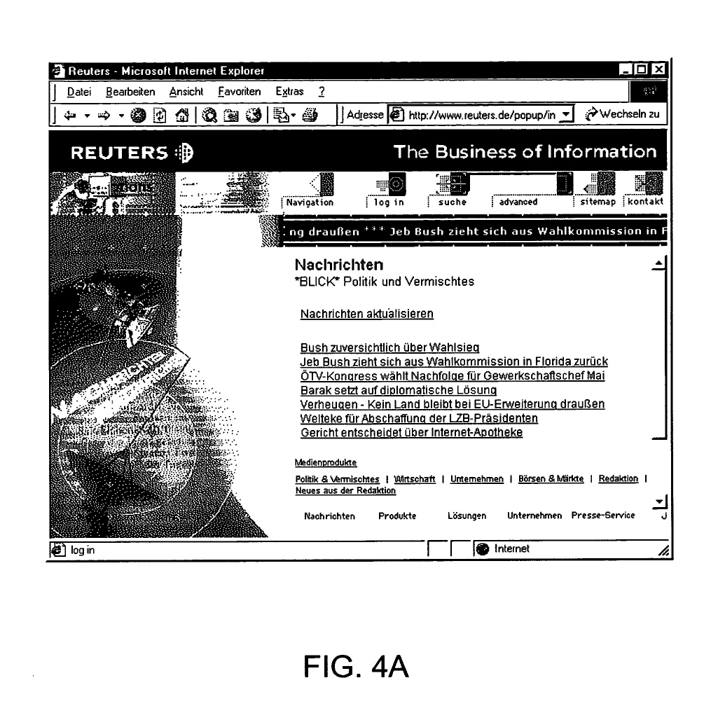

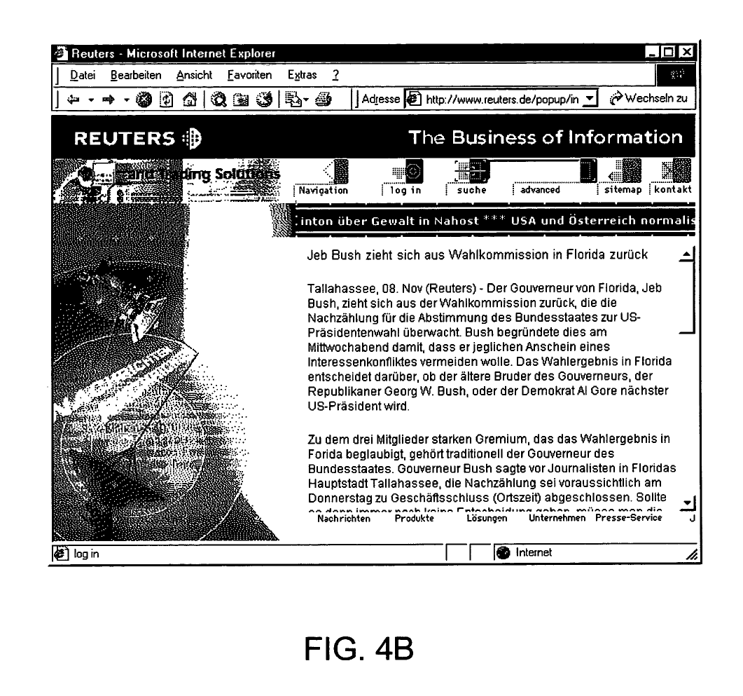

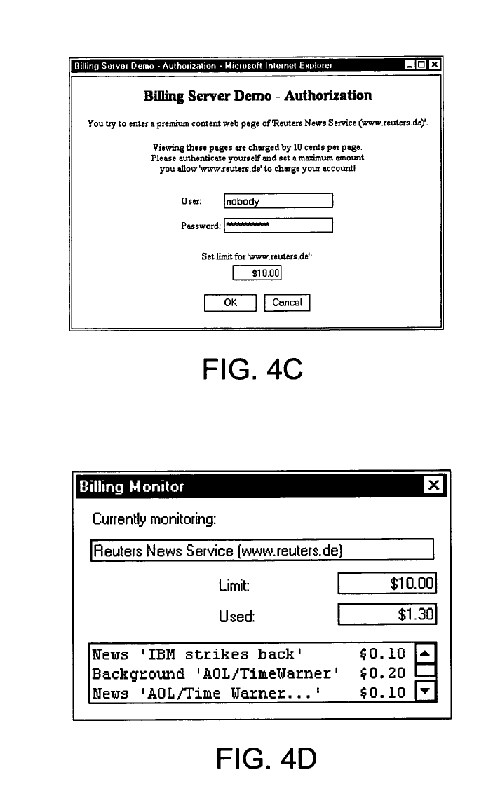

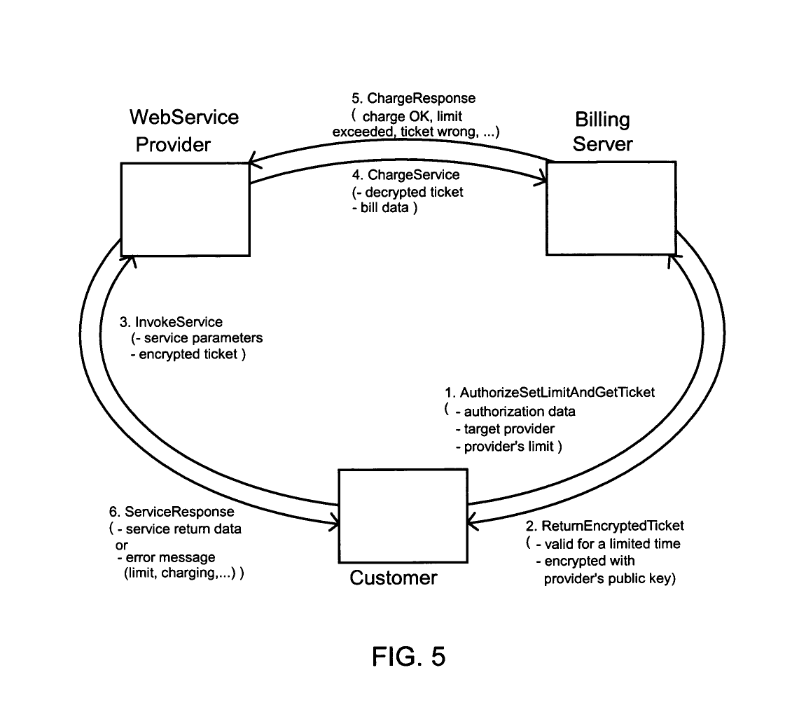

Optionally, a small program provided by the third party may be implemented that displays the remaining account limit for the current vendor. The last debits are listed there as well. In case of a web browser this program is visualized by a small window that is updated by the third party system (cf. FIGS. 4A to 4D).

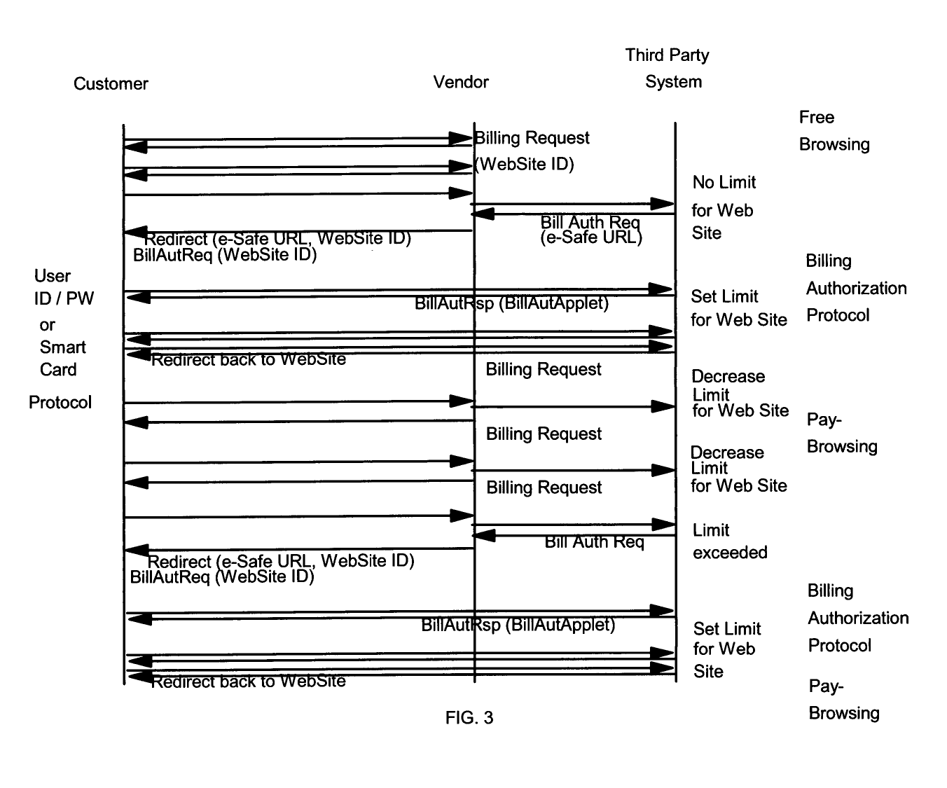

An example for a customer browsing with a web browser in the internet is shown in FIG. 3. This example is a specific implementation of the invention. However, the invention is not restricted to this example.

Free Browsing:

The customer is browsing on the vendor's Web Site. After some clicks he follows a link to a premium content. The Web Site sends a Billing Request to the trusted third party. Because the customer has not set a limit for the WebSite, the trusted third party returns a Billing Authorization Request (Bill Auth Req) to the Web Site. The Web Site itself sends a Redirect request to the customer. This request instructs the customer to authenticate with the trusted third party first.

Billing Authorization Protocol:

By getting the redirect request the customer's browser sends a Billing Authorization Request (BillAutReq) to the trusted third party, i.e., a request for authenticating the customer. The trusted third party returns a web page containing a Java Applet (BillAutApplet) as a Billing Authorization Response (BillAuthRsp). Using this Applet the customer authenticates himself by User ID/Password or by Smart Card Protocol. After a successful authentication the customer sets a limit for the vendor (Set Limit for vendor). The last response of the trusted third party is a “Redirect back to vendor” request that sends the customer to the originally requested page, the premium content.

Pay-Browsing:

Due to the previous received “Redirect back to vendor” request the customer's web browser requests the originally requested premium content. Like in the “Free Browsing” case the vendor tries to debit the customer's account sending a Billing Request. This time the user is authenticated and has set a limit for the vendor, so the request succeeds and leeds to a “Decrease Limit for vendor” action of the trusted third party. This browsing can go on with other pages on the vendor's Web Site. Each time the customer clicks on a premium content page the generated Billing Request sent by the vendor to the trusted third party succeeds.

After using more pages containing premium content the limit the customer has set for the vendor exceeds. So the Billing Request leads to a “Limit Exceeded” error on the trusted third party. The trusted third party returns a Billing Authorization Request (Bill Auth Req) to the vendor. Now the above described Billing Authorization Protocol procedure takes place again.

Thus, in the present invention, payment information is exchanged only between the vendor and the billing service. The customer and the vendor, however, can communicate anonymously, i.e., no identification data is exchanged between the customer and the vendor. Accordingly, the invention provides an important contribution to the privacy of such systems.

In addition to that and in contrast to electronic cash systems like, e.g., Digicash, the customer does not need any virtual money in a wallet. Accordingly, there is no loss of interest, no loss of money in case the system crashes and there are less legal implications.

In order to implement the invention, at least the following components are needed. On the one side, there has to be a billing service (e.g., a software service provided over the network, e.g., the internet) having the following functions: an authentication engine, thus the customer is able to authenticate himself to the billing service; an authentication/limit setting engine, so the customer is able to set limits for each provider; and a charge engine, so that the vendor is able to charge the customer for using his services on the network.

The authentication/limit setting engine forms part of the software service mentioned above, which allows the customer to set the limit and other possible restrictions.

On the other side, there has to be a provider API, e.g., a programming library for implementing the charging mechanism in the vendor's software or at least a technical description of the expected format and data if a billing request is sent over the network to the billing server.

An optional control element for monitoring of billing can be present as well. To implement such a billing monitor, the following additions are made: the billing service additionally includes an API to access the data that should be displayed and the billing service or the customer (in the case of WebServices) additionally include a monitor API or at least a description about how to communicate to the billing server for monitoring data. The billing service additionally includes a monitor API to access the data that should be displayed. This API can be used by the vendor or the customer to retrieve the current status.

In the following, some examples for the implementation of the invention are given.

1) HTTP News Service

Let's see a news service like the Reuters news page in Germany. Today Reuters' news are for free. When clicking on a link the detailed news article is displayed free of charge. However, in case Reuters would charge a small amount for these services, the invention would work as follows:

The customer accesses the homepage of Reuters (FIG. 4A). There he will get a list of current news. News older than one hour can be read without being charged (FIG. 4B). Premium content, that is actual news and value added information, can only be displayed after paying a small amount, e.g., 5 cents.

The first time the customer clicks on an article for which he must pay he is redirected by the vendor's web server to the authorization page of the billing system (FIG. 4C). There he will then identify himself by entering a user ID and password, using a smartcard and a secret number or any other applicable authorization mechanism. At that time, the customer may also authorize the respective vendor (in the given example Reuters) to bill up to a certain amount, e.g. $10. In the redirection request, the vendor encodes some data like proposed limit, error URL and success URL. Veiled to the customer this data is transmitted to the billing system embedded in the HTML code of the web page. Thus, data is provided to the billing system in so-called “hidden fields”, so that the vendor and the billing system do not communicate with each other directly at his time.

The given limit cannot be exceeded by the vendor. In case the vendor will charge the pages without delivering them to the customer, there is only a small risk for the customer as he would lose only the maximum amount of e.g. $10.

After a successful authorization, the billing system redirects the customer to the requested news article, providing anonymous billing information in this redirect command, e.g. a shortly valid unique ID (“ticket”) that Reuters must use to bill the activities of the customer. This ticket must be encrypted by the public key of Reuters so that nobody else than Reuters can bill the customer with this ticket.

Now the customer can use any article on the Reuters' page during this browser session. Reuters bills for every request on premium content and is responsible for labelling all premium content adequately.

If billing is necessary, Reuters' charges for the customer using the above mentioned ticket. The answer of this billing request is either a positive answer or an error message, in case, e.g., the vendor tries to bill an amount that would exceed the limit.

The authorization cycle described above restarts only if the user exceeds his limit set for the respective vendor, or if the customer visits another vendor.

Additionally the customer can control all billing by an optional billing monitor (FIG. 4D).

2) MP3 download

Today most MP3 files on the internet are for free. Some of them are free of any copyright, many of them are illegal copies of popular songs. This popular song cannot be sold easily over the internet because of the lack of an adequate billing system.

In the following a sample scenario for mp3.com, a WebSite for free and legal mp3 songs, will be described:

The customer accesses the homepage of mp3.com. He decides to download and hear some free mp3 songs, this can be a song of an unknown artist or a low quality test song of a popular artist. After that he decides to download some popular songs for a charge, e.g. the full length high quality version of a song he could hear for no charge before. Like in the previous HTTP news service example the customer is redirected by the vendor to the billing service by mp3.com the first time the customer clicks on a mp3 file that must be charged. The customer must authorize himself and set a limited amount that can be charged by mp3.com. After successful authorization the customer is redirected back to mp3.com by the billing system. Like in the example above a ticket must be provided that enables mp3.com to charge the customer's downloads. The customer can now download mp3 files as long as the limit he set for mp3.com is not exceeded. Otherwise he must reauthorize himself and heighten the limit he has previously set for the specific provider.

In this example the optional billing monitor can be used as well (cf. FIG. 4C).

3) WebServices

The WebServices Technology is an emerging technology that describes autarchic services somewhere in the network that can be used by customers. These services are used via open protocols such as Simple Object Access Protocol (SOAP). A key element in this technology is the ability of having a central repository that holds information about different services. This repository can be used by customers to find a suitable service for their needs while designing the application or even during the run-time. The proposed architecture of WebServices does not cover billing in details yet.

A sample scenario for using the invention conjoined with WebServices is as follows:

The customer wants to use a service of the WebService Provider. The WebService Provider charges 10 cents for every successful service request. To enable charging, the customer must supply a unique number that can be used by the WebService Provider for billing, often called the “ticket”.

1. The customer requests the billing server for a ticket. In order to get this ticket he must provide data for authorization, e.g. user ID and password, the name or address of the WebService Provider and a limit. The provider is authorized to charge his service up to this specified limit.

2. If authorization succeeds the billing server returns a ticket. It is only usable by the WebService Provider because the ticket is encrypted by its public key. This ticket is only valid for a specified period of time, e.g. one hour.

3. The customer now invokes the WebService Provider providing all necessary parameters and the retrieved encrypted key.

4. The WebService Provider checks the request parameters, decrypts the ticket and charges the service using the billing server.

5. The billing server checks the validity of the ticket and the limit and returns an OK or an error.

6. In case the billing server returns an OK, the service is executed and the customer will get his return data of the service. In case of an error occurred in steps 4/5, the WebService Provider returns an error message to the customer.

Now the customer may use the WebService Provider (steps 3 to 6) until the service responds an error message due to an exceeded limit. The customer must now start with step 1 again to continue using the service.

The (micro)payment system of the present invention allows a customer to authorize a vendor to debit a certain amount from his account at a trusted third party. Thus, the customer can, e.g., implicitly pay for several documents until the amount authorized for the vendor is used up and the vendor software requests authorization again in order to be able to debit more money. Accordingly, the present invention provides for a real “Pay per Click:” on information web sites.

The invention described also allows a customer to optionally monitor any debit of the vendor and the resulting decrease of the amount authorized for that vendor.

1. A network-based method for performing cashless payments between a customer and a vendor providing services in said network, whereby an amount from a customer's account at a trusted third party is debited by said vendor for each access of said customer to said vendor's services provided on said network, characterized in that
said method comprises the step of assigning a limited maximum amount to said customer's account and allowing said vendor to debit said customer's account at said trusted third party for each access to said vendor's network service until said limited maximum amount is reached by performing a single authorization step for said assigned limited maximum amount before the first access to said vendor's network services.

2. A method according to claim 1, characterized in that said cashless payments are micropayments.

3. A method according to claim 1 or 2, characterized in that payment information is exchanged only between said vendor and said trusted third party.

4. A method according to any one of claims 1 to 3, characterized in that said customer and said vendor communicate anonymously.

5. A method according to any one of claims 1 to 4, characterized in that said customer is a software that automatically requests said network services.

6. A method according to any one of claims 1 to 5, characterized in that said trusted third party is a billing system.

7. A method according to any one of the preceding claims, characterized in that said authorization step includes an authorization cycle mechanism.

8. A method according to claim 7, characterized in that said authorization cycle mechanism can be used with mobile phones, personal digital assistants, and the like.

9. A method according to claim 7, characterized in that said access to said vendor's network service is done by a web browser using HTML.

10. A method according to any one of the preceding claims, characterized in that said customer and said vendor communicate through a billing authorization protocol.

11. A method according to any one of the preceding claims, characterized in that the level of said limited maximum amount depends on the respective vendor.

12. A method according to any one of the proceeding claims, characterized in that said trusted third party registers said limited maximum amount.

13. A method according to any one of the preceding claims, characterized in that said trusted third party registers additional optional information pertaining to said limited maximum amount.

14. A method according to claim 13, characterized in that said additional optional information is a time limit or service type restrictions.

15. A method according to any one of the preceding claims, characterized in that a new authorization has to be performed in case the limited maximum amount is exceeded.

16. A method according to any one of the preceding claims, characterized in that said method additionally comprises the step of monitoring the details of each payment.

17. A method according to any one of the preceding claims, characterized in that said authorization step is performed by identifying said user to said vendor.

18. A method according to claim 17, characterized in that identifying is performed by means of a smart card, a user ID and a password, a private key authenticated message, a biometric authentication method or the like.

19. A method according to any one of the preceding claims, characterized in that said limited maximum amount is checked before performing an access to said vendor's services oprovided n said network.

20. A method according to claim 19, characterized in that said limited maximum amount is checked by said vendor.

21. A method according to claim 19, characterized in that said limited maximum amount is checked by said trusted third party.

22. A computer program product stored on a computer usable medium, comprising computer readable program means for causing a computer to perform a method according to any one of claims 1 to 21 when said program is executed on seid computer.

23. A system for performing cashless payments between a customer and a vendor providing services in said network, whereby an amount from a customer's account at a trusted third party is debitable by said vendor for each access of said customer to said vendor's services provided on said network, said system comprising
a) authentication means for authenticating said customer;
b) limit setting and limit checking device means setting and checking a limited maximum amount to said customer's account;
c) charging means for allowing said vendor to send billing requests; and
d) means for accessing said trusted third party by software.

24. A system according to claim 22, additionally comprising
e) means for displaying a remaining account limit for a respective vendor; and
f) means for setting optional instructions in addition to said limit.

25. A system according to claim 23, characterized in that said means for displaying include a software program.
